(19) United States
(12) Patent Application Publication
(10) Pub. No.: US 2020/0198399 A1
(43) Pub. Date: Jun. 25, 2020

(54) MULTILAYER INNER TUBE

(71) Applicant: TPU PLUS GMBH, Aachen (DE)

(72) Inventor: Patrick Mattfeld, Aachen (DE)

(21) Appl. No.: 16/782,337

(22) Filed: Feb. 5, 2020

Related U.S. Application Data
(63) Continuation of application No. PCT/EP2018/071615, filed on Aug. 9, 2018.

(30) Foreign Application Priority Data
Aug. 11, 2017 (DE) DE102017118314.0

(51) Int. Cl. B60C 9/00; B60C 1/00; B32B 27/08

(52) U.S. Cl. CPC B60C 9/0042; B60C 1/0008; B60C 9/0238; B32B 27/08; B60C 9/005

(57) ABSTRACT

A multi-layer inner tube for a vehicle wheel, the multi-layer inner tube including an inner layer that is in contact with a gaseous filling of the inner tube; and an outer layer that differs from the inner layer, wherein the outer layer is in contact with an exterior environment of the inner tube, and wherein the inner layer and the outer layer are made from a thermoplastic polyurethane; and an intermediary layer made from an ethylene vinyl alcohol copolymer arranged between the inner layer and the outer layer.

### RELATED APPLICATIONS

This application is a continuation of International application PCT/EP2018/071615 filed on Aug. 9, 2018, claiming priority from German patent application DE 10 2017 118 314.0 filed on Aug. 11, 2017, both of which are incorporated in their entirety by this reference.

### FIELD OF THE INVENTION

The invention relates to a multilayer inner tube for a vehicle wheel, the multilayer inner tube comprising an inner layer that is in contact with a gas filling of the inner tube and an outer layer wherein the outer layer is different from the inner layer and in contact with outer surroundings of the inner tube, wherein the inner layer and the outer layer are made from thermoplastic polyurethane.

### BACKGROUND OF THE INVENTION

Bicycles typically have tires that include a shell and an air-filled inner tube. The shell maintains the tire form stable against an interior pressure of the inner tube, transfers acceleration forces, braking forces and lateral support forces to a road surface and typically has a profile. The inner tube is provided with a valve for filling and airtight so that it maintains an interior pressure.

Multilayer inner tubes with an inner layer and an outer layer made from thermoplastic polyurethane (also designated as TPU or TPUR) avoid the disadvantages of single-layer inner tubes, in particular lack of airtightness and fail safety of traditional single-layer butyl or rubber inner tubes. Using TPU furthermore helps to reduce a weight of the inner tube. JP H-035213 A proposes to form a multilayer inner tube of the type recited supra with a stabilizing inner layer made from a polyolefin, polystyrene, polybutadiene, PVC or polyisopropen.

Various inner tubes made from TPU or including TPU are known in the art. Thus, WO 2015/155596 A1 discloses a single-layer inner tube made from TPU. FR 2 598 653 A1 proposes to provide an inner tube with a powder as a release agent for welding on an inside. WO 2014/150550 A1 discloses a tube with an inner layer made from TPU configured as a glue layer and a release layer coextruded there above.

Various multilayer inner tubes are known in the art. FR 2 335 335 A1 proposes to produce a two-layer inner tube by submerging a mold initially in butyl latex and then in natural rubber and subsequently jointly vulcanizing both layers. DE 26 53 211 A1 proposes to coat a natural rubber inner tube with polyisobutyls. U.S. Pat. No. 6,418,991B1 to reinforce an inner tube with a puncture resistant polyamide fabric. DE 10 2010 026582A1 and EP 1940605B1 propose to provide an inner tube towards a running surface with a chamber that is filled with a gel. DE 27 25702 A1 and CN 205 326 695 U respectively describe tube tires with a support shell between two elastomeric layers. CN 202 042 296 U discloses a multilayer heat-resistant tube with an intermediary layer made from a silica gel.

Furthermore WO 2012/1511223 A1 discloses a multi layer foil packaging with intermediary layers made from an ethylene vinyl alcohol copolymer as a gas barrier

### BRIEF SUMMARY OF THE INVENTION

Thus, it is an object of the invention to provide an improved inner tube. Improving upon the known inner tubes, the invention proposes a multi-layer inner tube for a vehicle wheel, the multi-layer inner tube including an inner layer that is in contact with a gaseous filling of the inner tube; and an outer layer that differs from the inner layer, wherein the outer layer is in contact with an exterior environment of the inner tube, and wherein the inner layer and the outer layer are made from a thermoplastic polyurethane; and an intermediary layer made from an ethylene vinyl alcohol copolymer arranged between the inner layer and the outer layer. An inner tube of this type provides better airtightness.

Advantageously, an inner tube according to the invention includes an additional intermediary layer made from a gel and arranged between the inner layer and the outer layer. A gel is a viscoelastic non-demixing mix made from a solid component and a liquid component. An inner tube of this type provides increased fail safety because the viscoelastic gel closes punctures closed by damages and envelopes foreign objects in a sealing manner.

Advantageously, the gel cures when it comes in contact with air. An inner tube of this type has increased fail safety because the curing gel permanently closes remaining holes in the adjacent inner or outer layer that are caused by damages.

The gel in an inner tube according to the invention advantageously includes agarose. Agarose (CAS 9012-36-6) is a strong and cost-effective water-soluble gel forming agent with high resistance against aging.

Advantageously, an inner tube according to the invention includes an additional intermediary layer that is temperature resistant up to 220 degrees C. between the inner layer and the outer layer. TPU is temperature resistant up to 180 degrees C. An inner tube of this type has increased temperature resistance compared to an inner tube according to the invention that is exclusively made from extruded TPU.

Advantageously, an inner tube according to the invention includes an additional intermediary layer made from an identical thermoplastic polyurethane or from another thermoplastic polyurethane. An inner tube of this type includes further increased airtightness and fail safety. Furthermore, an inner tube of this type also provides the option to fill two intermediary spaces between TPU layers with different materials. The number of the TPU layers is limited in particular by the production methods, in particular the possible layer thicknesses. With current technology inner tubes according to the invention with up to 13 TPU layers are producible.

Advantageously, the outer layer at an inner tube according to the invention is foamed. An inner tube of this type improves a tribological contact between the inner tube and the shell and thus reduces power loss in this contact.

Advantageously, an inner tube according to the invention is produced by cutting a blank with two tube ends from an endless tube-shaped multilayered extruded material and the blank is closed into a torus shape and the two tube ends are welded together. This method of producing inner tubes is well known in the art.

Further advantageously, a protective layer is applied according to the method according to the invention initially at a seam on an inside of a first hose end, then a second hose end is pushed beyond the seam over the first hose end and eventually the hose ends are pressed together flat at the seam between two clamping jaws that are moved towards each other and welded in this position, wherein the protective layer prevents a welding of the inside of the first hose end. A method of this type prevents a formation of flashing at the seam.

In inner tubes according to the invention, the layers are connected with each other inseparably and are typically only identifiable as layers under a microscope.

### BRIEF DESCRIPTION OF THE DRAWINGS

The invention is subsequently described based on embodiments with reference to drawing figures, wherein:

FIG. 1 illustrates a sectional view of a first inner tube according to the invention;

FIG. 2 illustrates a sectional view of a second inner tube according to the invention;

FIG. 3 illustrates a sectional view of a third inner tube according to the invention; and

FIG. 4 illustrates a sectional view of a fourth inner tube according to the invention;

### DETAILED DESCRIPTION OF THE INVENTION

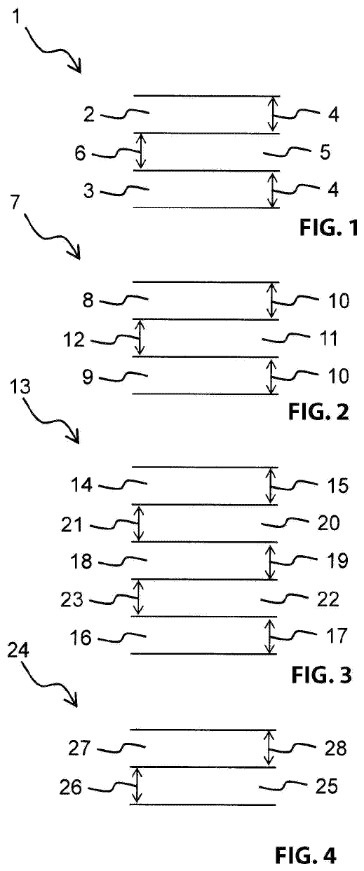

The first inner tube 1 according to the invention that is illustrated in a sectional view in FIG. 1 includes an inner layer 2 and an outer layer 3 with a thickness 4 of 170 μm respectively, wherein both are made from TPU (trade name BASF Elastollan SP 883) and an intermediary layer (5) with a thickness (6) of 10 μm made from EVAL (trade name EVAL F101B). The first inner tube (1) provides a very high level of air tightness.

The second inner tube 7 according to the invention illustrated in FIG. 2 includes an intermediary layer 11 with a thickness 12 of 50 μm made from a gel made from a liquid sealant milk (trade name TUNE One Shot) and Agarosis between an inner layer 8 and an outer layer 9 that have a respective thickness 10 of 150 μm respectively. In addition the second inner tube 7 corresponds to the first inner tube 1. The second inner tube 7 is characterized by a high level of fail safety.

The third inner tube 13 illustrated in FIG. 3 in a sectional view includes a first intermediary layer 18 with a thickness 19 of 100 μm between an inner layer 14 with a thickness 15 of 100 μm and an outer layer 16 with a thickness 17 of 50 μm, wherein all layers are made from the TPU recited supra.

The third inner tube 13 includes a second intermediary layer 20 with a thickness 21 of 10 μm made from the EVAL recited supra between the inner layer 14 and the first intermediary layer 18 and a heat resistant additional intermediary layer 22 with a thickness 23 of 100 μm made from a polystyrene-ethylene-butylene-copolymer (trade name KRATON A1535H) between the first intermediary layer 18 and the outer layer 16. The third inner tube 13 is characterized by a high level of air tightness and heat resistance.

The fourth inner tube 24 according to the invention illustrated in a sectional view in FIG. 4, only includes an outer layer 25 with a thickness 26 of 250 μm made from a very soft elastic TPU (trade name BASF Elastollan Soft 45A) and an inner layer 27 with a thickness 28 made from the harder TPU recited supra (Elastolann SP883). The inner tube 24 is characterized by a very low roll resistance and a low level of chum induced energy loss and thus very good driving comfort.

The illustrated inner tubes 1, 7, 13 and 24 according to the invention are initially produced in an endless manner in a hose shape by blow foil extrusion with TPU on a polyester basis together with the fillings between the TPU layers 2, 3, 8, 9, 14, 16, 18 cut to length and welded together in a torus shape. The outer layers 3, 9, 16 and 25 are foamed. The inner tubes 1, 7, 13 and 24 according to the invention are suitable for a 29″ bicycle wheel that is not illustrated and includes an outer diameter of 30 mm in a non-pressurized condition.

### REFERENCE NUMERALS AND DESIGNATIONS

1 inner tube
2 inner layer
3 outer layer
4 thickness
5 intermediary layer
6 thickness
7 inner tube
8 inner layer
9 outer layer
10 thickness
11 intermediary layer
12 thickness
13 inner tube
14 inner layer
15 thickness
16 outer layer
17 thickness
18 intermediary layer
19 thickness
20 intermediary layer
21 thickness
22 intermediary layer
23 thickness
24 inner tube
25 outer layer
26 thickness
27 inner layer
28 thickness

1. A multi-layer inner tube for a vehicle wheel, the multi-layer inner tube comprising:
an inner layer that is in contact with a gaseous filling of the inner tube; and
an outer layer that differs from the inner layer,
wherein the outer layer is in contact with an exterior environment of the inner tube, and
wherein the inner layer and the outer layer are made from a thermoplastic polyurethane; and
an intermediary layer made from an ethylene vinyl alcohol copolymer arranged between the inner layer and the outer layer.

2. The multilayer inner tube according to claim 1, further comprising: an intermediary layer made from a gel and arranged between the inner layer and the outer layer.

3. The multilayer inner tube according to claim 2, wherein the gel hardens in contact with air.

4. The multilayer inner tube according to claim 4, wherein the gel includes Agarose.

5. The multilayer inner tube according to claim 1, further comprising an intermediary layer that is heat resistant up to 220° C. and arranged between the inner layer and the outer layer.

6. The multilayer inner tube according to claim 1, further comprising: an intermediary layer made from thermoplastic polyeurthane.

7. The multilayer inner tube according to claim 1, wherein the outer layer is foamed.

8. A method for producing the multilayer inner tube according to claim 1, the method comprising:
cutting a blank with two hose ends from an endless hose shaped multilayer extruded material;
closing the blank into a torus shape; and
welding the two hose ends together.

9. The method according to claim 8, comprising:
applying a protective layer to an inside of a first hose end; thereafter
pushing a second hose end beyond a seam over the first hose end; thereafter
pressing the two hose ends together flat at the seam between two clamping jaws that are being moved towards each other; and eventually thereafter
welding the hose ends together,
wherein the protective layer prevents a welding of an inside of the first hose end.
